(19) United States
(12) Patent Application Publication
(10) Pub. No.: US 2016/0217138 A1
(43) Pub. Date: Jul. 28, 2016

(54) SYSTEM AND METHOD FOR EXECUTING AND DISPLAYING RESULTS OF COMPOSITE QUERIES

(71) Applicant: TRUSTED WEB SERVICES LTD., London (GB)

(72) Inventor: Paul Adam ROSENTHAL, Bet Shemesh (IL)

(73) Assignee: TRUSTED WEB SERVICES LTD., London (GB)

(21) Appl. No.: 14/605,584

(22) Filed: Jan. 26, 2015

(51) Int. Cl. G06F 17/30

(52) U.S. Cl. CPC G06F 17/3053

(57) ABSTRACT

A system including variable parameter selection functionality operable for facilitating selection of a variable parameter of a composite query, parameter value assigning functionality operable for facilitating assignment to each parameter other than the variable parameter, one of the possible values associated therewith, composite query execution functionality operable, responsive to selection of the variable parameter and to assignment of the value to each parameter other than the variable parameter, for automatically executing the composite query for each possible value of the variable parameter, thereby being operable for receiving a multiplicity of composite query execution results corresponding to the multiplicity of possible values associated with the variable parameter, and composite query results display functionality operable, responsive to receiving the multiplicity of composite query execution results, for displaying, for each possible value associated with the variable parameter, a corresponding composite query execution result of the multiplicity of composite query execution results.

### FIELD OF THE INVENTION

The present invention relates generally to systems and methods for executing composite queries and for displaying a multiplicity of composite query execution results associated therewith.

### BACKGROUND OF THE INVENTION

As mobile application and internet search capabilities become more powerful, there arises a need for improved tools for analyzing results of such searches. In particular, search engine optimization tools utilize data pertaining to the results of such searches for improving rankings of entities returned by such searches and for market intelligence. The present invention seeks to provide improved tools for querying the results of historical searches as well as improved tools for displaying statistical information pertaining thereto.

### SUMMARY OF THE INVENTION

The present invention seeks to provide a system and method for executing and displaying results of composite queries.

There is thus provided in accordance with a preferred embodiment of the present invention a system for executing a composite query and for displaying a multiplicity of composite query execution results associated therewith, the composite query including a multiplicity of parameters including an explicit parameter and at least one implicit parameter, each of the multiplicity of parameters having a multiplicity of possible values associated therewith, each of the multiplicity of composite query execution results corresponding to an execution of the composite query wherein each of the multiplicity of parameters is assigned one of the multiplicity of possible values associated therewith, the multiplicity of possible values associated with the explicit parameter corresponding to a multiplicity of explicit queries historically executed by at least one user, the multiplicity of possible values associated with each of the at least one implicit parameter corresponding to a multiplicity of circumstances under which the explicit queries were historically executed, each of the composite query execution results including data pertaining to results of historical executions of an explicit query corresponding to a value assigned to the explicit parameter, each of the results resulting from a historical execution of the explicit query under a combination of circumstances corresponding to the values assigned to the at least one implicit parameter, the system including variable parameter selection functionality operable for facilitating selection, by a user, of a variable parameter from the multiplicity of parameters of the composite query, parameter value assigning functionality operable for facilitating assignment by the user, to each of the multiplicity of parameters of the composite query which is not the variable parameter selected by the user via the variable parameter selection functionality, one of the multiplicity of possible values associated therewith, composite query execution functionality operable, responsive to the selection of the variable parameter and to the assignment of the value to each of the multiplicity of parameters which is not the variable parameter selected by the user via the variable parameter selection functionality, for automatically executing the composite query for each possible value of the multiplicity of possible values associated with the variable parameter, thereby being operable for receiving a multiplicity of composite query execution results corresponding to the multiplicity of possible values associated with the variable parameter, and composite query results display functionality operable, responsive to the receiving the multiplicity of composite query execution results corresponding to the multiplicity of possible values associated with the variable parameter, for displaying, for each possible value of the multiplicity of possible values associated with the variable parameter, a corresponding composite query execution result of the multiplicity of composite query execution results.

Preferably, the explicit query is at least one of a database and an internet query. Preferably, the internet query includes at least one of a textual search, an image search, a location based search, a voice search and an internet based request for recommendations of services.

Preferably, the explicit query is initiated by at least one of providing an explicit search term and employing explicit search functionality. Preferably, the explicit search functionality includes at least one of a clickable option to search for entities in a vicinity of said user, which vicinity is ascertained by the functionality. Preferably, the explicit search term is entered into and executed by at least one of an internet search provider and a mobile application. Preferably, the explicit search functionality is provided by at least one of an internet search provider and a mobile application. Preferably, the results of the historical executions of the explicit query include a multiplicity of entities corresponding to the explicit query. Preferably, each of the multiplicity of entities includes at least one of a business provider, service provider, individual, location, organization and an entity which is advertised or accessible via the internet.

Preferably, the multiplicity of circumstances includes at least one of a model of a computing device from which the explicit query was executed, a location of the computing device at which time the explicit query was executed, a time of day at which the explicit query was executed, a particular day of the week at which time the explicit query was executed, whether the computing device was stationary or moving at which time the explicit query was executed, whether a user of the computing device was walking or driving at which time the explicit query was executed, a method of transportation employed by the user of the computing device at which time the explicit query was executed, a direction and speed of motion of the device at which time the explicit query was executed, and a mobile computing application via which the explicit query was executed.

Preferably, the data pertaining to the results of the historical executions of the explicit query includes at least one of a frequency of appearance of a particular entity within the historical results of the query, a ranking of a particular entity within the historical results of the query, statistics pertaining to a frequency of appearance of a particular advertised product within the historical results, statistics pertaining to a price of a particular advertised product within the historical results, and a manner by which a particular product is advertised by a particular entity, such as by any combination of text, images, videos, customer feedback pertaining to the particular product, customer feedback pertaining to a particular entity, and statistics pertaining to a price of a particular entity.

Preferably, the variable parameter selected by the user is one of the explicit parameter and the at least one implicit parameter. Preferably, the composite query results display functionality is also operable for displaying comparative information comparing current composite query execution results with historical composite query execution results of any particular composite query.

There is also provided in accordance with another preferred embodiment of the present invention a method for executing a composite query and for displaying a multiplicity of composite query execution results associated therewith, the composite query including a multiplicity of parameters including an explicit parameter and at least one implicit parameter, each of the multiplicity of parameters having a multiplicity of possible values associated therewith, each of the multiplicity of composite query execution results corresponding to an execution of the composite query wherein each of the multiplicity of parameters is assigned one of the multiplicity of possible values associated therewith, the multiplicity of possible values associated with the explicit parameter corresponding to a multiplicity of explicit queries historically executed by at least one user, the multiplicity of possible values associated with each of the at least one implicit parameter corresponding to a multiplicity of circumstances under which the explicit queries were historically executed, each of the composite query execution results including data pertaining to results of historical executions of an explicit query corresponding to a value assigned to the explicit parameter, each of the results resulting from a historical execution of the explicit query under a combination of circumstances corresponding to the values assigned to the at least one implicit parameter, the method including selecting, by a user, a variable parameter from the multiplicity of parameters of the composite query, to each of the multiplicity of parameters of the composite query which is not the variable parameter selected by the user, assigning, by the user, one of the multiplicity of possible values associated therewith, responsive to the selection of the variable parameter and to the assignment of the value to each of the multiplicity of parameters which is not the variable parameter selected by the user, automatically executing the composite query for each possible value of the multiplicity of possible values associated with the variable parameter, thereby receiving a multiplicity of composite query execution results corresponding to the multiplicity of possible values associated with the variable parameter, and responsive to the receiving the multiplicity of composite query execution results corresponding to the multiplicity of possible values associated with the variable parameter, displaying, for each possible value of the multiplicity of possible values associated with the variable parameter, a corresponding composite query execution result of the multiplicity of composite query execution results.

Preferably, the explicit query is at least one of a database and an internet query. Preferably, the internet query includes at least one of a textual search, an image search, a location based search, a voice search and an internet based request for recommendations of services.

Preferably, the explicit query is initiated by at least one of providing an explicit search term and employing explicit search functionality. Preferably, the explicit search functionality includes at least one of a clickable option to search for entities in a vicinity of said user, which vicinity is ascertained by the functionality. Preferably, the explicit search term is entered into and executed by at least one of an internet search provider and a mobile application. Preferably, the explicit search functionality is provided by at least one of an internet search provider and a mobile application. Preferably, the results of the historical executions of the explicit query include a multiplicity of entities corresponding to the explicit query. Preferably, each of the multiplicity of entities includes at least one of a business provider, service provider, individual, location, organization and an entity which is advertised or accessible via the internet.

Preferably, the multiplicity of circumstances includes at least one of a model of a computing device from which the explicit query was executed, a location of the computing device at which time the explicit query was executed, a time of day at which the explicit query was executed, a particular day of the week at which time the explicit query was executed, whether the computing device was stationary or moving at which time the explicit query was executed, whether a user of the computing device was walking or driving at which time the explicit query was executed, a method of transportation employed by the user of the computing device at which time the explicit query was executed, a direction and speed of motion of the device at which time the explicit query was executed, and a mobile computing application via which the explicit query was executed.

Preferably, the data pertaining to the results of the historical executions of the explicit query includes at least one of a frequency of appearance of a particular entity within the historical results of the query, a ranking of a particular entity within the historical results of the query, statistics pertaining to a frequency of appearance of a particular advertised product within the historical results, statistics pertaining to a price of a particular advertised product within the historical results, and a manner by which a particular product is advertised by a particular entity, such as by any combination of text, images, videos, customer feedback pertaining to the particular product, customer feedback pertaining to a particular entity, and statistics pertaining to a price of a particular entity.

Preferably, the variable parameter selected by the user is one of the explicit parameter and the at least one implicit parameter. Preferably, the method also includes displaying comparative information comparing current composite query execution results with historical composite query execution results of any particular composite query.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system for executing and displaying results of composite queries, constructed and operative in accordance with a preferred embodiment of the present invention;

FIG. 2 is a simplified flowchart of the operation of the system of FIG. 1; and

FIG. 3 is a simplified pictorial illustration of an example of a user interface which communicates with system of FIG. 1.

### DETAILED DESCRIPTION OF A PREFERRED EMBODIMENT

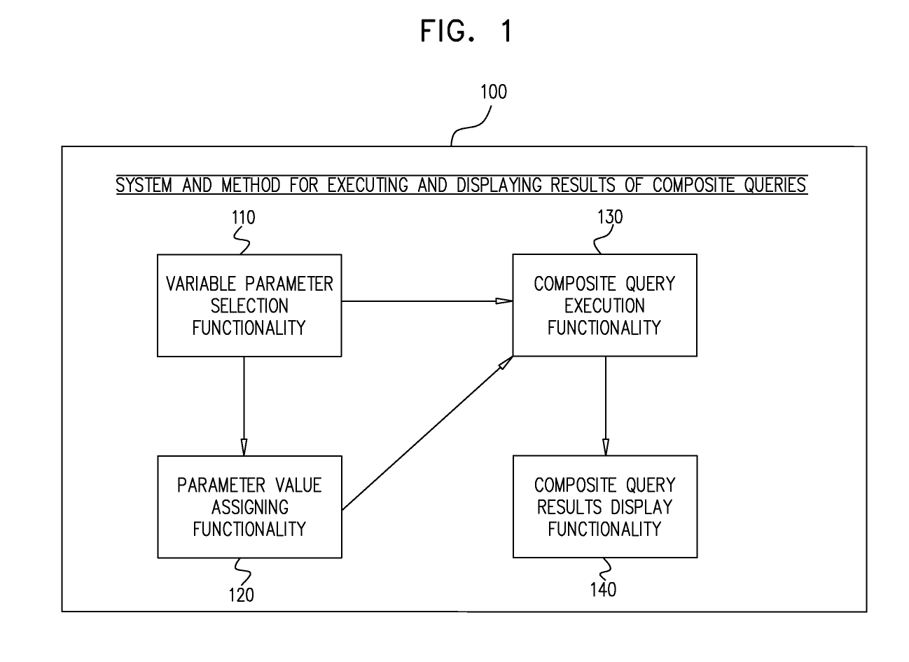

Reference is now made to FIG. 1, which is a simplified pictorial illustration of a system for executing and displaying results of composite queries, constructed and operative in accordance with a preferred embodiment of the present invention.

For the purpose of the present application, a “composite query” is defined as a query including a multiplicity of parameters, wherein one of the parameters is an explicit parameter and at least one of the parameters is an implicit parameter. Each of the parameters preferably has a multiplicity of possible values associated therewith.

The value assigned to the explicit parameter corresponds to an explicit query historically executed by a user. Such an explicit query may be, for example, a search query against a database or an internet search query. Such an internet search query may include, for example, a textual search, an image search, a location based search, a voice search, an internet based request for recommendations regarding various services, and any other search for information available on the internet or via a mobile application which search was initiated or requested by a user, whether by providing an explicit search term or by employing functionality provided, for example, by an internet search provider or by a mobile application. Such functionality may include, for example, a clickable option to search for entities in a vicinity of the user, which vicinity is ascertained by the functionality.

It is appreciated that an explicit query may be entered and executed by a user via, for example, a mobile application residing on a mobile communicator device which application provides internet-based search capabilities, or a web site which provides internet-based search capabilities. It is further appreciated that the results of an execution of an explicit query typically include a multiplicity of entities corresponding to the explicit query. For the purpose of the present application, an “entity” may include, for example, any business provider, service provider, individual, location, organization or any other entity which is advertised or accessible via the internet.

The implicit parameters may each be assigned a value corresponding to a particular circumstance under which any explicit query was executed. These circumstances may include, for example, a model of a computing device from which the explicit query was executed, a location of the computing device at which time the explicit query was executed, a time of day at which time the explicit query was executed, a particular day of the week at which time the explicit query was executed, whether the computing device was stationary or moving at which time the explicit query was executed, whether the user of the computing device was walking or driving at which time the explicit query was executed, a method of transportation employed by the user at which time the explicit query was executed, a direction and speed of motion of the device at which time the explicit query was executed and a mobile computing application via which the explicit query was executed.

Each of the composite query execution results preferably includes data pertaining to results of historical executions of the explicit query, wherein each of the results resulted from a historical execution of the explicit query under a combination of circumstances corresponding to the values assigned to the implicit parameters. For example, data pertaining to historical executions of a search query may comprise statistics pertaining to a frequency of appearance or ranking of a particular entity within historical results of the query. Such data may also include, for example, statistics pertaining to a frequency of appearance of a particular advertised product within historical results, or to a price thereof. The data may also include, for example, a manner by which a particular product is advertised by a particular entity, such as by any combination of text, images, videos, customer feedback pertaining to the particular product, customer feedback pertaining to a particular entity, and statistics pertaining to a price of a particular entity.

The system 100 illustrated in FIG. 1 preferably comprises variable parameter selection functionality 110 operable for facilitating selection, by a user, of a variable parameter from the multiplicity of parameters of a composite query to be executed. It is appreciated that the variable parameter selected by the user may be any of the explicit parameter and the implicit parameters included in the composite query. It is further appreciated that system 100 is operable for executing the composite query for each possible value of the selected variable parameter, as will be described hereinbelow.

System 100 also preferably includes parameter value assigning functionality 120 operable for facilitating assignment by the user, to each of the multiplicity of parameters of the composite query which is not a variable parameter selected by the user via variable parameter selection functionality 110, one of the multiplicity of possible values associated therewith. It is appreciated that system 100 is operable for executing the composite query for the assigned values of the parameters, as will be described hereinbelow.

It is a particular feature of the present invention that system 100 also preferably includes composite query execution functionality 130 operable, responsive to selection of a variable parameter via variable parameter selection functionality 110 and to assignment of a value to each of the multiplicity of parameters which is not the variable parameter via parameter value assigning functionality 120, for automatically executing the composite query for each possible value of the multiplicity of possible values associated with the variable parameter, thereby being operable for receiving a multiplicity of composite query execution results corresponding to the multiplicity of possible values associated with the variable parameter.

It is a further particular feature of the present invention that system 100 also preferably includes composite query results display functionality 140 operable, responsive to receiving the multiplicity of composite query execution results corresponding to the multiplicity of possible values associated with the variable parameter, for displaying, for each possible value of the multiplicity of possible values associated with the variable parameter, a corresponding composite query execution result. It is appreciated that composite query results display functionality 140 may also be operable for displaying comparative information comparing current composite query execution results with historical composite query execution results of any particular composite query.

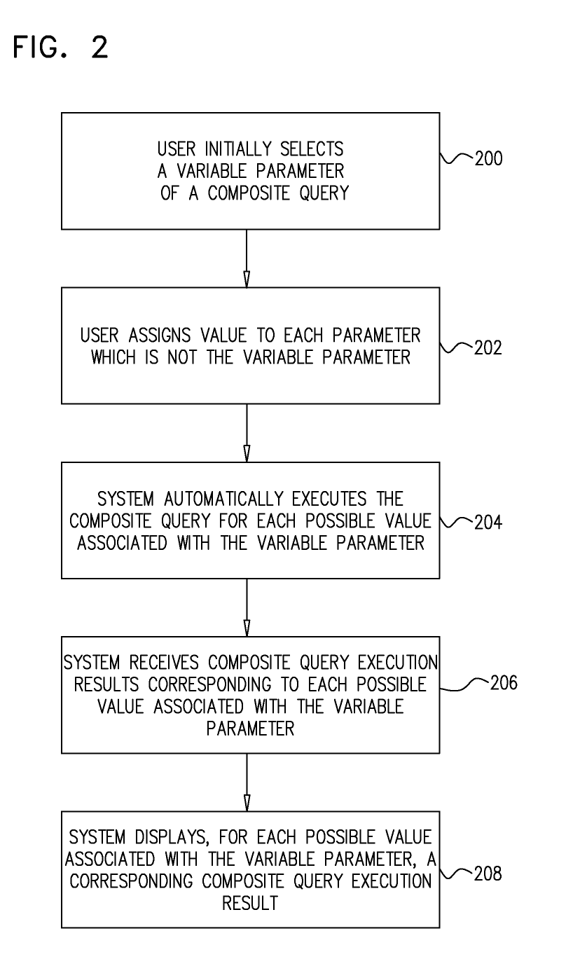

Reference is now made to FIG. 2, which is a simplified flowchart of the operation of the system of FIG. 1.

As shown in FIG. 2 a user preferably initially selects a variable parameter from the multiplicity of parameters of a composite query (200). It is appreciated that the variable parameter selected by the user may be any of the explicit parameter and the implicit parameters included in the composite query.

Thereafter, to each of the multiplicity of parameters of the composite query which is not the variable parameter selected by the user in step 200 hereinabove, the user preferably assigns one of the multiplicity of possible values associated therewith (202).

Responsive to the selection of the variable parameter and to the assignment of a value to each of the multiplicity of parameters which is not the variable parameter selected by the user in step 200 hereinabove, the system then preferably automatically executes the composite query for each possible value of the multiplicity of possible values associated with the variable parameter (204), thereby receiving a multiplicity of composite query execution results corresponding to the multiplicity of possible values associated with the variable parameter (206).

Responsive to receiving the multiplicity of composite query execution results corresponding to the multiplicity of possible values associated with the variable parameter, the system then preferably displays, for each possible value of the multiplicity of possible values associated with the variable parameter, a corresponding composite query execution result of the multiplicity of composite query execution results (208).

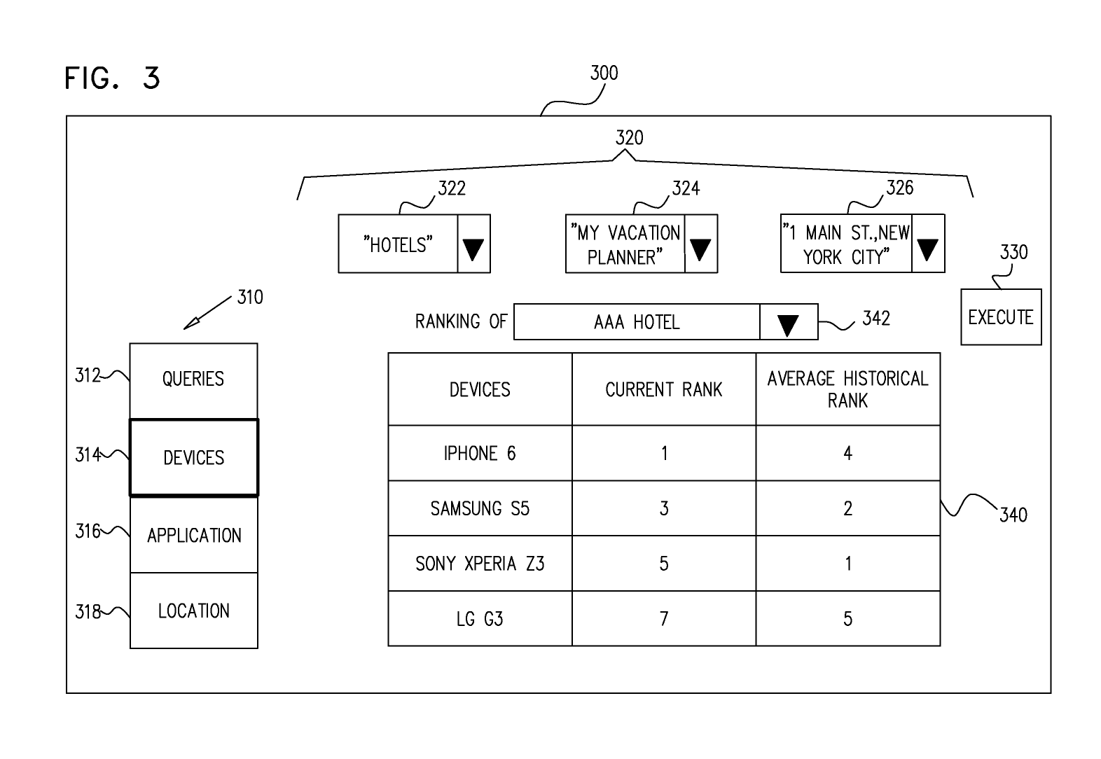

Reference is now made to FIG. 3, which is a simplified pictorial illustration of an example of a user interface which communicates with system 100 of FIG. 1.

As shown in FIG. 3 a computerized display mechanism 300 is provided for facilitating compiling, by a user, a composite query to be executed by system 100, and for displaying a multiplicity of composite query execution results associated therewith. Computerized display mechanism 300 may be implemented, for example, as a computerized user interface subsystem which resides on a suitable computing device, such as a desktop or laptop computer, a computer server, or a suitable mobile computing device. It is appreciated that computerized display mechanism 300 is preferably operable for communicating with composite query execution functionality 130 and with composite query results display functionality 140 (FIG. 1).

In the example of FIG. 3, computerized display mechanism 300 preferably includes a variable parameter selection interface 310 which facilitates selection, by a user of display mechanism 300, of a variable parameter from the multiplicity of parameters of a composite query to be executed. It is appreciated that variable parameter selection interface 310 preferably communicates with variable parameter selection functionality 110 (FIG. 1).

As clearly shown in FIG. 3, variable parameter selection interface 310 comprises a multi-option menu comprising a multiplicity of selectable parameters of a composite query, and includes an explicit parameter and implicit parameters which may be included in a composite query to be executed by system 100.

The explicit parameter illustrated in the example of FIG. 3 is a “Queries” parameter 312, a value of which may be any explicit query historically executed by a user, as described hereinabove with reference to FIG. 1.

The implicit parameters illustrated in the example of FIG. 3 include a model 314 of a computing device from which the explicit query was executed, a mobile computing application 316 via which the explicit query was executed, and a location of the computing device at which time the explicit query was executed 318. As described hereinabove, it is appreciated that variable parameter selection interface 310 may include any additional implicit parameter which may be included in a composite query to be executed by system 100.

Computerized display mechanism 300 preferably also includes a parameter value selection interface 320 operable for facilitating selection, by a user of display mechanism 300, for each of the multiplicity of parameters of the composite query which is not a variable parameter selected by the user via variable parameter selection interface 310, one of a multiplicity of possible values associated therewith. It is appreciated that variable parameter selection interface 320 preferably communicates with parameter value assigning functionality 120 (FIG. 1).

As clearly shown in FIG. 3, parameter value selection interface 320 includes selection elements 322, 324 and 326, each of elements 322, 324 and 326 corresponding to a parameter of the composite query which are not a variable parameter selected by the user via variable parameter selection interface 310. Each of selection elements 322, 324 and 326 preferably includes a multiplicity of selectable values corresponding to the possible values associated therewith. It is appreciated that elements 322, 324 and 326 are dynamically populated by parameter value selection functionality 320 responsive to selection of a variable parameter by the user via variable parameter selection interface 310. It is further appreciated that parameter value selection interface 320 may include additional selection elements to facilitate composite queries having additional parameters.

In the example of FIG. 3, a user has employed variable parameter selection interface 310 to select parameter 314 as the variable parameter of the composite query to be executed. As described hereinabove, parameter 314 pertains to a model of a computing device from which the explicit query of the composite query was executed. Therefore, parameter value selection interface 320 has populated selection elements 322 to include selectable values corresponding to the multiplicity of parameters of the composite query which is not variable parameter 314 selected by the user, namely explicit “Queries” parameter 322, implicit mobile computing application parameter 324 and implicit location parameter 326.

As further shown in the example of FIG. 3, the user has selected the value “hotels” as the value of the explicit “Queries” parameter 322, the value “My Vacation Planner” as the value of the implicit mobile computing application parameter 324, and “1 Main St., New York City” as the value of implicit location parameter 326.

Computerized display mechanism 300 preferably also includes a composite query execution command interface 330 operable to receive, from a user, an instruction to execute the composite query compiled by the user via variable parameter selection interface 310 and parameter value selection interface 320. In the example of FIG. 3, composite query execution command interface 330 is a clickable button within computerized display mechanism 300. Composite query execution command interface 330 is preferably operable for communicating with composite query execution functionality 130 and for instructing composite query execution functionality 130 to execute the composite query compiled by the user.

Computerized display mechanism 300 preferably also includes a composite query results interface 340 operable to communicate with composite query results display functionality 140 and to display, for each possible value of the multiplicity of possible values associated with the variable parameter selected by the user via variable parameter selection interface 310, a corresponding composite query execution result. As described hereinabove, each of the composite query execution results preferably includes data pertaining to results of historical executions of the explicit query, wherein the results of executions of the explicit query typically include a multiplicity of entities corresponding to the explicit query. In the example of FIG. 3, a multi-option menu 342 comprising a multiplicity of selectable entities is preferably provided for facilitating selection, by a user, of a particular entity for which display of composite query execution results is desired. Alternatively, other selection mechanisms may be provided, for selecting a multiplicity of entities for which display of composite query execution results is desired.

In the example of FIG. 3, for each possible value of variable parameter 314 selected by the user, namely for each computing device model, composite query results interface 340 is operable to display a composite query result pertaining to entities resulting from the explicit query “hotels”, which explicit query was executed via the “My Vacation Planner” application and which explicit query was executed by a user located at 1 Main St., New York City.

As described hereinabove, the explicit search query “hotels” may have been executed, for example, as any of a textual search, an image search, a location based search, a voice search, an internet based request for recommendations regarding hotel accommodations, and any other search for information available on the internet or via a mobile application which search was initiated or requested by a user, whether by providing an explicit search term or by employing functionality provided, for example, by an internet search provider or by a mobile application.

In the example of FIG. 3, the results of each query displayed by composite query results interface 340 include comparative information pertaining to a ranking of each hotel entity within historical results of the explicit search query “hotels”. By employing multi-option menu 342, a particular hotel entity for which display of comparative ranking information is selected.

As clearly shown in FIG. 3, the ranking information includes information pertaining to a current ranking of the particular hotel among other hotels returned by the search query “hotels”, which ranking corresponds to a most recent execution of the explicit query “hotels”. As further shown in FIG. 3, the ranking information also includes comparative information pertaining to a comparison between a current ranking of the particular hotel as compared with historical rankings of the particular hotel as deduced from historical results of the explicit query “hotels”. Composite query results display functionality 140 is thereby instrumental in providing a user of computerized display mechanism 300 with useful information regarding the effectiveness of advertisements of the particular hotel in drawing attention from users executing the explicit query.

It is appreciated that in the example of FIG. 3, composite query results interface 340 and multi-option menu 342 are displayed together with the elements 310, 312, 314, 316, 318, 320, 322, 324, 326 and 330. Alternatively, composite query results interface 340 may be displayed on an alternative display screen which may be launched, for example, upon activating composite query execution command interface 330.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A system for executing a composite query and for displaying a multiplicity of composite query execution results associated therewith, said composite query comprising a multiplicity of parameters including an explicit parameter and at least one implicit parameter, each of said multiplicity of parameters having a multiplicity of possible values associated therewith;
each of said multiplicity of composite query execution results corresponding to an execution of said composite query wherein each of said multiplicity of parameters is assigned one of said multiplicity of possible values associated therewith;
said multiplicity of possible values associated with said explicit parameter corresponding to a multiplicity of explicit queries historically executed by at least one user;
said multiplicity of possible values associated with each of said at least one implicit parameter corresponding to a multiplicity of circumstances under which said explicit queries were historically executed;
each of said composite query execution results comprising data pertaining to results of historical executions of an explicit query corresponding to a value assigned to said explicit parameter, said data pertaining to said results of said historical executions of said explicit query comprising at least one of:
a frequency of appearance of a particular entity within said historical results of said query;
a ranking of a particular entity within said historical results of said query;
statistics pertaining to a frequency of appearance of a particular advertised product within said historical results;
statistics pertaining to a price of a particular advertised product within said historical results;
a manner by which a particular product is advertised by a particular entity, such as by any combination of text, images, videos and customer feedback pertaining to said particular product;
customer feedback pertaining to a particular entity within said historical results; and
statistics pertaining to a price of a particular entity within said historical results;
each of said composite query execution results resulting from a historical execution of said explicit query under a combination of circumstances corresponding to the values assigned to said at least one implicit parameter, said combination of circumstances including at least:
a model of a computing device from which said explicit query was executed;
a location of said computing device at which time said explicit query was executed; and
a mobile computing application via which said explicit query was executed;
said system comprising a computer comprising a processor, a memory and a non-transitory, tangible computer-readable medium in which computer program instructions are stored, which instructions, when read by said computer, cause the computer to provide the following functionalities:
variable parameter selection functionality operable for facilitating selection, by a user, of a variable parameter from said multiplicity of parameters of said composite query;
parameter value assigning functionality operable for facilitating assignment by said user, to each of said multiplicity of parameters of said composite query which is not said variable parameter selected by said user via said variable parameter selection functionality, one of said multiplicity of possible values associated therewith;
composite query execution functionality operable, responsive to said selection of said variable parameter and to said assignment of said value to each of said multiplicity of parameters which is not said variable parameter selected by said user via said variable parameter selection functionality, for automatically executing said composite query for each possible value of said multiplicity of possible values associated with said variable parameter, thereby being operable for receiving a multiplicity of composite query execution results corresponding to said multiplicity of possible values associated with said variable parameter; and
composite query results display functionality operable, responsive to said receiving said multiplicity of composite query execution results corresponding to said multiplicity of possible values associated with said variable parameter, for displaying, for each said possible value of said multiplicity of possible values associated with said variable parameter, a corresponding composite query execution result of said multiplicity of composite query execution results.

2. The system according to claim 1 and wherein said explicit query is at least one of a database and an internet query.

3. The system according to claim 2 and wherein said internet query comprises at least one of a textual search, an image search, a location based search, a voice search and an internet based request for recommendations of services.

4. The system according to claim 2 and wherein said explicit query is initiated by at least one of providing an explicit search term and employing explicit search functionality.

5. The system according to claim 4 and wherein said explicit search functionality comprises at least one of a clickable option to search for entities in a vicinity of said user, which vicinity is ascertained by said functionality.

6. The system according to claim 4 and wherein said explicit search term is entered into and executed by at least one of an internet search provider and a mobile application.

7. The system according to claim 4 and wherein said explicit search functionality is provided by at least one of an internet search provider and a mobile application.

8. The system according to claim 1 and wherein said results of said historical executions of said explicit query comprise a multiplicity of entities corresponding to said explicit query.

9. The system according to claim 8 and wherein each of said multiplicity of entities comprises at least one of a business provider, service provider, individual, location, organization and an entity which is advertised or accessible via the internet.

10. The system according to claim 1 and wherein said multiplicity of circumstances includes at least one of:
a time of day at which said explicit query was executed;
a particular day of the week at which time said explicit query was executed;
whether said computing device was stationary or moving at which time said explicit query was executed;
whether a user of said computing device was walking or driving at which time said explicit query was executed;
a method of transportation employed by said user of said computing device at which time said explicit query was executed; and
a direction and speed of motion of said device at which time said explicit query was executed.

11. (canceled)

12. The system according to claim 1 and wherein said variable parameter selected by said user is one of said explicit parameter and said at least one implicit parameter.

13. The system according to claim 1 and wherein said composite query results display functionality is also operable for displaying comparative information comparing current composite query execution results with historical composite query execution results of any particular composite query.

14. A method for executing a composite query and for displaying a multiplicity of composite query execution results associated therewith, said composite query comprising a multiplicity of parameters including an explicit parameter and at least one implicit parameter, each of said multiplicity of parameters having a multiplicity of possible values associated therewith;
each of said multiplicity of composite query execution results corresponding to an execution of said composite query wherein each of said multiplicity of parameters is assigned one of said multiplicity of possible values associated therewith;
said multiplicity of possible values associated with said explicit parameter corresponding to a multiplicity of explicit queries historically executed by at least one user;
said multiplicity of possible values associated with each of said at least one implicit parameter corresponding to a multiplicity of circumstances under which said explicit queries were historically executed;
each of said composite query execution results comprising data pertaining to results of historical executions of an explicit query corresponding to a value assigned to said explicit parameter, said data pertaining to said results of said historical executions of said explicit query comprising at least one of:
a frequency of appearance of a particular entity within said historical results of said query;
a ranking of a particular entity within said historical results of said query;
statistics pertaining to a frequency of appearance of a particular advertised product within said historical results;
statistics pertaining to a price of a particular advertised product within said historical results;
a manner by which a particular product is advertised by a particular entity, such as by any combination of text, images, videos and customer feedback pertaining to said particular product;
customer feedback pertaining to a particular entity within said historical results; and
statistics pertaining to a price of a particular entity within said historical results;
each of said composite query execution results resulting from a historical execution of said explicit query under a combination of circumstances corresponding to the values assigned to said at least one implicit parameter, said combination of circumstances including at least:
a model of a computing device from which said explicit query was executed;
a location of said computing device at which time said explicit query was executed; and
a mobile computing application via which said explicit query was executed;
said method comprising:
selecting, by a user, a variable parameter from said multiplicity of parameters of said composite query;
to each of said multiplicity of parameters of said composite query which is not said variable parameter selected by said user, assigning, by said user, one of said multiplicity of possible values associated therewith;
responsive to said selection of said variable parameter and to said assignment of said value to each of said multiplicity of parameters which is not said variable parameter selected by said user, automatically executing said composite query for each possible value of said multiplicity of possible values associated with said variable parameter, thereby receiving a multiplicity of composite query execution results corresponding to said multiplicity of possible values associated with said variable parameter; and
responsive to said receiving said multiplicity of composite query execution results corresponding to said multiplicity of possible values associated with said variable parameter, displaying, for each said possible value of said multiplicity of possible values associated with said variable parameter, a corresponding composite query execution result of said multiplicity of composite query execution results.

15. The method according to claim 14 and wherein said explicit query is at least one of a database and an internet query.

16. The method according to claim 15 and wherein said internet query comprises at least one of a textual search, an image search, a location based search, a voice search and an internet based request for recommendations of services.

17. The method according to claim 15 and wherein said explicit query is initiated by at least one of providing an explicit search term and employing explicit search functionality.

18. The method according to claim 17 and wherein said explicit search functionality comprises at least one of a clickable option to search for entities in a vicinity of said user, which vicinity is ascertained by said functionality.

19. The method according to claim 17 and wherein said explicit search term is entered into and executed by at least one of an internet search provider and a mobile application.

20. The method according to claim 17 and wherein said explicit search functionality is provided by at least one of an internet search provider and a mobile application.

21. The method according to claim 14 and wherein said results of said historical executions of said explicit query comprise a multiplicity of entities corresponding to said explicit query.

22. The method according to claim 21 and wherein each of said multiplicity of entities comprises at least one of a business provider, service provider, individual, location, organization and an entity which is advertised or accessible via the internet.

23. The method according to claim 14 and wherein said multiplicity of circumstances includes at least one of:
a time of day at which said explicit query was executed;
a particular day of the week at which time said explicit query was executed;
whether said computing device was stationary or moving at which time said explicit query was executed;
whether a user of said computing device was walking or driving at which time said explicit query was executed;
a method of transportation employed by said user of said computing device at which time said explicit query was executed; and
a direction and speed of motion of said device at which time said explicit query was executed.

24. (canceled)

25. The method according to claim 14 and wherein said variable parameter selected by said user is one of said explicit parameter and said at least one implicit parameter.

26. The method according to claim 14 and also comprising displaying comparative information comparing current composite query execution results with historical composite query execution results of any particular composite query.
